(19) United States
(12) Patent Application Publication
(10) Pub. No.: US 2023/0350441 A1
(43) Pub. Date: Nov. 2, 2023

(54) POWER SUPPLY APPARATUS AND IMPEDANCE ADJUSTMENT METHOD THEREOF

(71) Applicant: Power Forest Technology Corporation, Hsinchu County (TW)

(72) Inventor: Hung-Chih Chiu, Taipei City (TW)

(73) Assignee: Power Forest Technology Corporation, Hsinchu County (TW)

(21) Appl. No.: 17/897,227

(22) Filed: Aug. 29, 2022

(30) Foreign Application Priority Data
Apr. 27, 2022 (TW) 111115995

(51) Int. Cl. G05F 1/46

(52) U.S. Cl. CPC G05F 1/46

(57) ABSTRACT

A power supply apparatus and an impedance adjustment method thereof are provided. An adjustment control circuit controls an impedance adjustment circuit to adjust an equivalent impedance of a feedback circuit according to variation of an output voltage of a power supply circuit, to adjust a feedback voltage in response to the variation of the output voltage.

### CROSS-REFERENCE TO RELATED APPLICATION

This application claims the priority benefit of Taiwanese application no. 111115995, filed on Apr. 27, 2022. The entirety of the above-mentioned patent application is hereby incorporated by reference herein and made a part of this specification.

### BACKGROUND

### Technical Field

The disclosure relates to a power supply apparatus. In particular, the disclosure relates to a power supply apparatus and an impedance adjustment method thereof.

### Description of Related Art

To increase an output voltage in a conventional power supply, a current source may be coupled to a resistor circuit (e.g., a feedback circuit implemented with a resistor circuit) connected to the output voltage, and the output voltage may be increased by providing currents to the resistor circuit. In this way, although the output voltage can be effectively increased, when variation of the load results in variation of the output voltage, a fluctuation amplitude ratio of a feedback voltage provided by the feedback circuit may be greater than a fluctuation amplitude ratio of the output voltage, causing failure in normal operation of the power supply. For example, when the feedback voltage is lower than a predetermined protection voltage, it may trigger the power supply to enter a low-voltage protection mode in which the output voltage is not provided normally.

### SUMMARY

The disclosure provides a power supply apparatus and an impedance adjustment method thereof, which ensure the normal operation of the power supply apparatus.

According to an embodiment of the disclosure, a power supply apparatus includes a power supply circuit, a feedback circuit, an impedance adjustment circuit, and an adjustment control circuit. The power supply circuit has an output terminal and a feedback terminal. The output terminal providing an output voltage, and the feedback terminal receiving a feedback voltage. The feedback circuit is coupled to the output terminal and the feedback terminal. The feedback circuit provides the feedback voltage according to the output voltage. The impedance adjustment circuit is coupled to the feedback circuit. The adjustment control circuit is coupled to the impedance adjustment circuit. The adjustment control circuit controls the impedance adjustment circuit to adjust an equivalent impedance of the feedback circuit according to variation of the output voltage to adjust the feedback voltage in response to the variation of the output voltage.

In an embodiment of the disclosure, the adjustment control circuit includes a detecting circuit and a control circuit. The detecting circuit detects the feedback voltage, the output voltage, or a current value flowing through the feedback circuit to generate output voltage variation information. The control circuit is coupled to the detecting circuit and the impedance adjustment circuit. The control circuit controls the impedance adjustment circuit to adjust the equivalent impedance of the feedback circuit according to the output voltage variation information and an impedance value of the feedback circuit.

In an embodiment of the disclosure, the impedance adjustment circuit includes a variable current source, a variable voltage source, or a variable resistor circuit.

In an embodiment of the disclosure, the impedance adjustment circuit includes a first current source, a switch, and a second current source. The first current source provides a first current. The switch is connected in series with the first current source between an operating voltage and the feedback circuit. The second current source is coupled between the switch and a reference voltage. The second current source provides a second current. The adjustment control circuit controls a conductive state of the switch according to the variation of the output voltage to adjust the equivalent impedance of the feedback circuit.

In an embodiment of the disclosure, the feedback circuit is a voltage-dividing resistor circuit.

In an embodiment of the disclosure, the feedback circuit includes a first resistor and a second resistor. The first resistor and the second resistor are connected in series between the output terminal of the power supply circuit and a reference voltage. A common contact of the first resistor and the second resistor is coupled to the feedback terminal of the power supply circuit. The feedback voltage is generated on the common contact of the first resistor and the second resistor.

According to an embodiment of the disclosure, an impedance adjustment method of a power supply apparatus is provided. The power supply apparatus includes a power supply circuit, a feedback circuit, and an impedance adjustment circuit. The power supply circuit has an output terminal and a feedback terminal. The output terminal provides an output voltage. The feedback terminal receives a feedback voltage provided by the feedback circuit according to the output voltage. The impedance adjustment circuit is coupled to the feedback circuit. The impedance adjustment method of the power supply apparatus includes the following. Variation of the output voltage is detected. The impedance adjustment circuit is controlled to adjust an equivalent impedance of the feedback circuit according to variation of the output voltage to adjust the feedback voltage in response to the variation of the output voltage.

In an embodiment of the disclosure, the impedance adjustment method of the power supply apparatus includes the following. The feedback voltage, the output voltage, or a current value flowing through the feedback circuit are detected to generate output voltage variation information. The impedance adjustment circuit is controlled to adjust the equivalent impedance of the feedback circuit according to the output voltage variation information and an impedance value of the feedback circuit.

In an embodiment of the disclosure, the impedance adjustment circuit includes a variable current source, a variable voltage source, or a variable resistor circuit.

In an embodiment of the disclosure, the feedback circuit is a voltage-dividing resistor circuit.

Based on the foregoing, the adjustment control circuit according to the embodiments of the disclosure may control the impedance adjustment circuit to adjust the equivalent impedance of the feedback circuit according to the variation of the output voltage of the power supply circuit to adjust the feedback voltage in response to the variation of the output voltage. As such, the feedback voltage can correctly reflect the variation of the output voltage, ensuring the normal operation of the power supply apparatus.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a power supply apparatus according to an embodiment of the disclosure.

FIG. 2 is a schematic diagram of a power supply apparatus according to another embodiment of the disclosure.

FIG. 3 is a schematic diagram of a power supply apparatus according to another embodiment of the disclosure.

FIG. 4 is a schematic diagram of a power supply apparatus according to another embodiment of the disclosure.

FIG. 5 is a flowchart of an impedance adjustment method of a power supply apparatus according to an embodiment of the disclosure.

### DESCRIPTION OF THE EMBODIMENTS

In order to make the disclosure more comprehensible, embodiments are particularly provided below as examples according to which the disclosure can be reliably carried out. In addition, wherever possible, elements/members/steps labeled with the same reference numerals in the drawings and embodiments denote the same or similar parts.

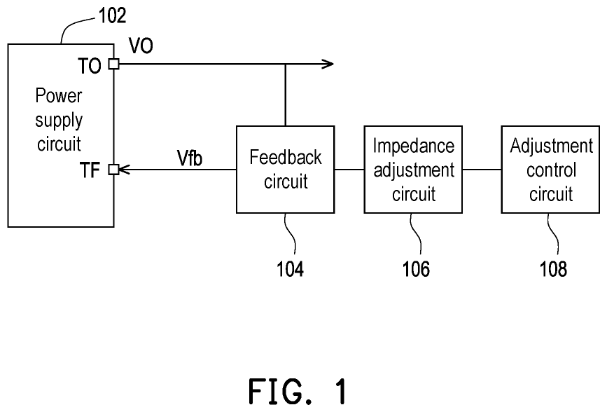

FIG. 1 is a schematic diagram of a power supply apparatus according to an embodiment of the disclosure. The power supply apparatus may include a power supply circuit 102, a feedback circuit 104, an impedance adjustment circuit 106, and an adjustment control circuit 108. The power supply circuit 102 has an output terminal TO and a feedback terminal TF. The feedback circuit 104 is coupled to the output terminal TO and the feedback terminal TF. The impedance adjustment circuit 106 is coupled to the feedback circuit 104 and the adjustment control circuit 108. The power supply circuit 102 may provide an output voltage VO at the output terminal TO, and the feedback terminal TF may receive a feedback voltage Vfb provided by the feedback circuit 104 according to the output voltage VO. The power supply circuit 102 may be a DC-DC conversion circuit, for example but not limited thereto. The impedance adjustment circuit 106 is configured to adjust an equivalent impedance of the feedback circuit 104. The adjustment control circuit 108 may control the impedance adjustment circuit 106 to adjust the equivalent impedance of the feedback circuit 104 according to the variation of the output voltage VO to adjust the feedback voltage Vfb in response to the variation of the output voltage VO.

As such, the feedback voltage Vfb can correctly reflect the variation of the output voltage VO. For example, a fluctuation amplitude ratio of the feedback voltage Vfb can be equal to a fluctuation amplitude ratio of the output voltage VO (for example, when the fluctuation amplitude ratio of the output voltage VO is 5%, the fluctuation amplitude ratio of the feedback voltage Vfb is also 5%). This prevents failure in normal operation of the power supply apparatus caused by the fluctuation amplitude ratio of the feedback voltage Vfb being greater than the fluctuation amplitude ratio of the output voltage VO. For example, when variation of the load at the output terminal of the power supply circuit 102 results in variation of the output voltage VO, it is possible to prevent the feedback voltage Vfb from being lower than a predetermined protection voltage due to the excessive fluctuation amplitude ratio, which triggers the power supply circuit 102 to enter a low-voltage protection mode in which the output voltage VO is not provided normally.

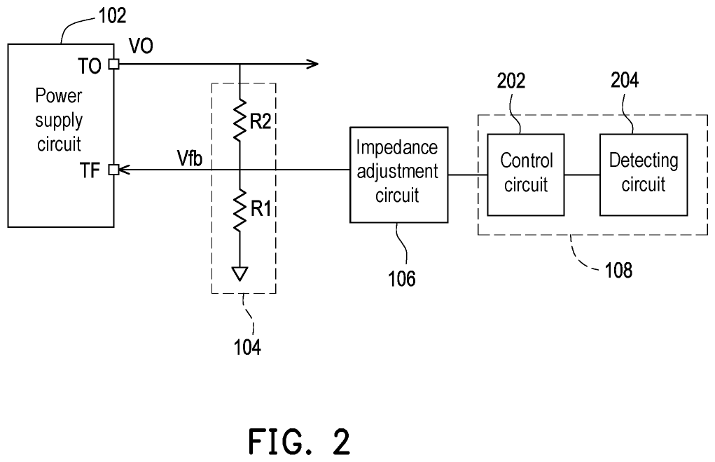

FIG. 2 is a schematic diagram of a power supply apparatus according to another embodiment of the disclosure. In this embodiment, the feedback circuit 104 is implemented with a voltage-dividing resistor circuit, and may include resistors R1 and R2, for example, but is not limited thereto in other embodiments. The adjustment control circuit 108 includes a control circuit 202 and a detecting circuit 204. The resistors R1 and R2 are connected in series between the output terminal TO of the power supply circuit 102 and a reference voltage. In this embodiment, the reference voltage is a ground voltage, but not limited thereto. A common contact of the resistors R1 and R2 are coupled to the feedback terminal TF of the power supply circuit 102 and the impedance adjustment circuit 106. The control circuit 202 is coupled to the impedance adjustment circuit 106 and the detecting circuit 204.

The resistors R1 and R2 may divide the output voltage VO to generate the feedback voltage Vfb on the common contact of the resistors R1 and R2. The detecting circuit 204 may be configured to detect variation of the output voltage VO to generate output voltage variation information. The voltage variation information is used to indicate the variation of the output voltage VO. For example, the detecting circuit 204 may obtain the output voltage variation information by directly detecting the output voltage VO, and may also obtain the voltage variation information of the output voltage VO by detecting the feedback voltage Vfb or the current flowing through the feedback circuit 104. For example, the output voltage VO may be calculated according to a detected voltage value of the feedback voltage Vfb and resistance values of the resistors R1 and R2 to obtain the output voltage variation information. Alternatively, the output voltage VO may be calculated according to currents flowing through the resistors R1 and R2 and the resistance values of the resistors R1 and R2 to obtain the output voltage variation information.

The control circuit 202 may control the impedance adjustment circuit 106 to adjust the equivalent impedance of the feedback circuit 104 according to the output voltage variation information and an impedance value of the feedback circuit 104. For example, the control circuit 202 may calculate the current or the voltage to be provided or the impedance to be adjusted by the impedance adjustment circuit 106 in response to the variation amplitude of the output voltage VO according to the ratio of the resistors R1 to R2 and the variation amplitude of the output voltage VO. Moreover, the control circuit 202 may control the impedance adjustment circuit 106 to provide a current or a voltage to the feedback circuit 104, or change a resistance value of the impedance adjustment circuit 106 to adjust the equivalent impedance of the feedback circuit 104. Accordingly, the feedback voltage Vfb output by the feedback circuit 104 is changed, so that the feedback voltage Vfb correctly reflects the variation of the output voltage VO. The impedance adjustment circuit 106 may be implemented, for example, with a variable current source, a variable voltage source, or a variable resistor circuit.

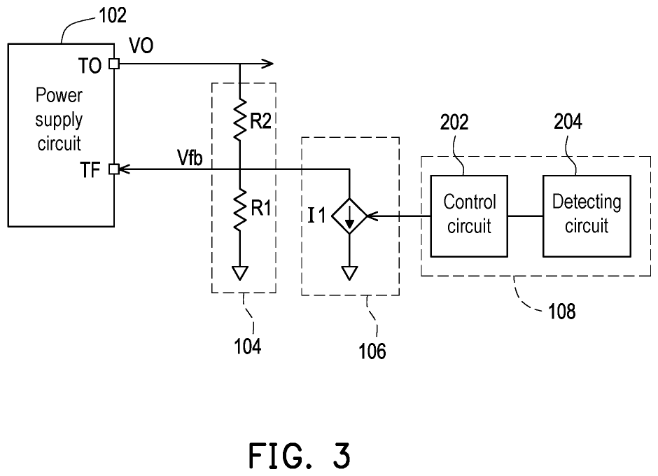

For example, FIG. 3 is a schematic diagram of a power supply apparatus according to another embodiment of the disclosure. In this embodiment, the impedance adjustment circuit 106 is implemented with a variable current source I1. In this embodiment, assuming that the resistance values of the resistors R1 and R2 are respectively 1K ohms and 4K ohms, and a current value provided by the variable current source I1 is 15/4 mA, then a voltage value of the output voltage VO is 20V (at this time, the currents flowing through the resistors R1 and R2 are respectively 1 mA and 19/4 mA, and the feedback voltage is 1V). When the voltage value of the output voltage VO drops to 19V due to variation of the load at the output terminal TO, if the current value provided by the variable current source I1 is maintained at 15/4 mA, the feedback voltage Vfb drops to 4/5V. In other words, when the output voltage VO is reduced by 5%, the feedback voltage Vfb is reduced by 20%.

To prevent this case, the control circuit 202 may control the variable current source I1 to adjust the current value provided thereby to 14/4 mA. As such, the currents flowing through the resistors R1 and R2 can be respectively 1 mA and 18/4 mA, and the feedback voltage Vfb is maintained at 1V. Therefore, the variation of the output voltage VO does not cause the feedback voltage Vfb to be lower than the predetermined protection voltage due to the excessive variation amplitude, which triggers the power supply circuit 102 to enter a low-voltage protection mode in which the output voltage VO is not provided normally. The adjustment to the current value of the variable current source I1 of this embodiment only serves as an exemplary embodiment, and the adjustment to the current value of the variable current source I1 is not limited thereto. For example, in other embodiments, the current value of the variable current source I1 may also be adjusted to other current values, so that the feedback voltage Vfb becomes 0.95V (that is, the fluctuation amplitude ratio of the feedback voltage Vfb is 5%, which is the same as the fluctuation amplitude ratio of the output voltage VO).

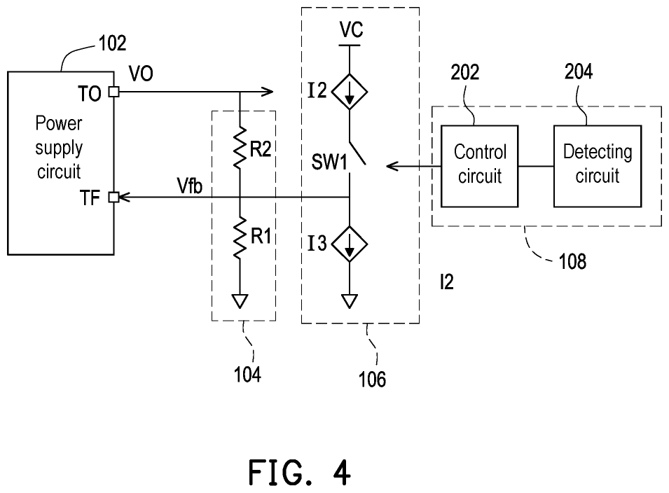

FIG. 4 is a schematic diagram of a power supply apparatus according to another embodiment of the disclosure. In this embodiment, the impedance adjustment circuit 106 is implemented with current sources I2 and I3 and a switch SW1. The current source I2 and the switch SW1 are coupled between an operating voltage VC and the feedback circuit 104, and the current source I3 is coupled between the switch SW1 and a ground. The current sources I2 and I3 are configured to respectively provide a first current and a second current, and the first current and the second current in this embodiment are respectively 1/4 mA and 15/4 mA. Similar to the embodiment of FIG. 3, it is assumed in this embodiment that the resistance values of the resistors R1 and R2 are respectively 1K ohms and 4K ohms. When the switch SW1 is OFF, the voltage value of the output voltage VO is 20V (at this time, the currents flowing through the resistors R1 and R2 are respectively 1 mA and 19/4 mA, and the feedback voltage is 1V). In addition, when the voltage value of the output voltage VO drops to 19V due to variation of the load at the output terminal TO, the control circuit 202 may turn on the switch SW1 according to the variation of the output voltage VO, so that the current value flowing through the resistor R2 is changed from 19/4 mA to 18/4 mA, maintaining the feedback voltage Vfb at 1V. In other embodiments, the current value of the first current may also be designed to be other values, so that the feedback voltage Vfb can be adjusted to other voltage values when the switch SW1 is turned on.

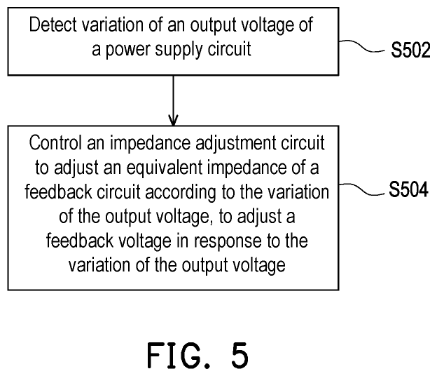

FIG. 5 is a flowchart of an impedance adjustment method of a power supply apparatus according to an embodiment of the disclosure. The power supply apparatus includes a power supply circuit, a feedback circuit, and an impedance adjustment circuit. The power supply circuit has an output terminal and a feedback terminal. In the power supply circuit, the output terminal may provide an output voltage, and the feedback terminal may receive the feedback voltage provided by the feedback circuit according to the output voltage. The impedance adjustment circuit is coupled to the feedback circuit. As shown from the embodiments above, the impedance adjustment method of the power supply apparatus may include the following. First, variation of the output voltage of the power supply circuit is detected (step S502). For example, output voltage variation information may be generated by detecting the feedback voltage provided by the feedback circuit, the output voltage of the power supply circuit, or a current value flowing through the feedback circuit. Next, the impedance adjustment circuit is controlled to adjust an equivalent impedance of the feedback circuit according to the variation of the output voltage to adjust the feedback voltage in response to the variation of the output voltage (step S504). For example, the impedance adjustment circuit may be controlled to adjust the equivalent impedance of the feedback circuit according to the output voltage variation information and an impedance value of the feedback circuit. The feedback circuit may be a voltage-dividing resistor circuit, for example. The impedance adjustment circuit may be a variable current source, a variable voltage source, or a variable resistor circuit, for example. The equivalent impedance of the feedback circuit can be adjusted by adjusting the current provided by the variable current source to the feedback circuit, by adjusting the voltage provided by the variable voltage source to the feedback circuit, or by adjusting the impedance of the variable resistor circuit coupled to the feedback circuit. Further, the feedback voltage can be adjusted in response to the variation of the output voltage. As such, the feedback voltage can correctly reflect the variation of the output voltage, ensuring the normal operation of the power supply apparatus.

In summary of the foregoing, the adjustment control circuit according to the embodiments of the disclosure may control the impedance adjustment circuit to adjust the equivalent impedance of the feedback circuit according to the variation of the output voltage of the power supply circuit, to adjust the feedback voltage in response to the variation of the output voltage. As such, the feedback voltage can correctly reflect the variation of the output voltage, ensuring the normal operation of the power supply apparatus.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A power supply apparatus comprising:
a power supply circuit having an output terminal and a feedback terminal, the output terminal providing an output voltage, and the feedback terminal receiving a feedback voltage;
a feedback circuit coupled to the output terminal and the feedback terminal, the feedback circuit providing the feedback voltage according to the output voltage;
an impedance adjustment circuit coupled to the feedback circuit; and
an adjustment control circuit coupled to the impedance adjustment circuit, the adjustment control circuit controlling the impedance adjustment circuit to adjust an equivalent impedance of the feedback circuit according to variation of the output voltage to adjust the feedback voltage in response to the variation of the output voltage.

2. The power supply apparatus according to claim 1, wherein the adjustment control circuit comprises:
a detecting circuit detecting the feedback voltage, the output voltage, or a current value flowing through the feedback circuit to generate output voltage variation information; and
a control circuit coupled to the detecting circuit and the impedance adjustment circuit, the control circuit controlling the impedance adjustment circuit to adjust the equivalent impedance of the feedback circuit according to the output voltage variation information and an impedance value of the feedback circuit.

3. The power supply apparatus according to claim 1, wherein the impedance adjustment circuit comprises a variable current source, a variable voltage source, or a variable resistor circuit.

4. The power supply apparatus according to claim 1, wherein the impedance adjustment circuit comprises:
a first current source providing a first current;
a switch connected in series with the first current source between an operating voltage and the feedback circuit; and
a second current source coupled between the switch and a reference voltage, the second current source providing a second current, wherein the adjustment control circuit controls a conductive state of the switch according to the variation of the output voltage to adjust the equivalent impedance of the feedback circuit.

5. The power supply apparatus according to claim 1, wherein the feedback circuit is a voltage-dividing resistor circuit.

6. The power supply apparatus according to claim 1, wherein the feedback circuit comprises:
a first resistor; and
a second resistor connected in series with the first resistor between the output terminal of the power supply circuit and a reference voltage, wherein a common contact of the first resistor and the second resistor is coupled to the feedback terminal of the power supply circuit, and the feedback voltage is generated on the common contact of the first resistor and the second resistor.

7. An impedance adjustment method of a power supply apparatus, the power supply apparatus comprising a power supply circuit, a feedback circuit, and an impedance adjustment circuit, the power supply circuit having an output terminal and a feedback terminal, the output terminal providing an output voltage, the feedback terminal receiving a feedback voltage provided by the feedback circuit according to the output voltage, the impedance adjustment circuit being coupled to the feedback circuit, and the impedance adjustment method of the power supply apparatus comprising:
detecting variation of the output voltage; and
controlling the impedance adjustment circuit to adjust an equivalent impedance of the feedback circuit according to variation of the output voltage to adjust the feedback voltage in response to the variation of the output voltage.

8. The impedance adjustment method according to claim 7, comprising:
detecting the feedback voltage, the output voltage, or a current value flowing through the feedback circuit to generate output voltage variation information; and
controlling the impedance adjustment circuit to adjust the equivalent impedance of the feedback circuit according to the output voltage variation information and an impedance value of the feedback circuit.

9. The impedance adjustment method according to claim 7, wherein the impedance adjustment circuit comprises a variable current source, a variable voltage source, or a variable resistor circuit.

10. The impedance adjustment method according to claim 7, wherein the feedback circuit is a voltage-dividing resistor circuit.
